(19) United States
(12) Patent Application Publication
(10) Pub. No.: US 2008/0107193 A1
(43) Pub. Date: May 8, 2008

(54) METHOD AND SYSTEM FOR AN IMPROVED MIMO MODULATION CODING SET FEEDBACK SYSTEM

(76) Inventors: Vinko Erceg, Cardiff, CA (US); Mark Kent, Vista, CA (US); Uri Landau, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/847,022

(22) Filed: Aug. 29, 2007

Related U.S. Application Data
(60) Provisional application No. 60/864,472, filed on Nov. 6, 2006.

(51) Int. Cl. H04L 27/28

(52) U.S. Cl. 375/260

(57) ABSTRACT

Aspects of a method and system for an improved MIMO modulation coding set feedback system may include determining, for each one of a plurality of spatial streams in a MIMO system, an index associated with an element of a modulation coding set, based on at least a reference index and an offset variable. The plurality of spatial streams may be modulated and coded, based on the determined index. A reference feedback variable may be fed back from a receiver to a transmitter in the MIMO system. The reference index may be determined based on at least the reference feedback variable. The offset variable for each one of the plurality of spatial streams may be fed back from a receiver to a transmitter in the MIMO system.

### CROSS-REFERENCE TO RELATED APPLICATIONS/INCORPORATION BY REFERENCE

This application makes reference to, claims priority to, and claims the benefit of U.S. Provisional Application Ser. No. 60/864,472, filed on Nov. 6, 2006.

The above referenced application is hereby incorporated herein by reference in its entirety.

### FIELD OF THE INVENTION

Certain embodiments of the invention relate to signal processing for communication systems. More specifically, certain embodiments of the invention relate to a method and system for an improved MIMO modulation coding set feedback system.

### BACKGROUND OF THE INVENTION

Mobile communications have changed the way people communicate and mobile phones have been transformed from a luxury item to an essential part of every day life. The use of mobile phones is today dictated by social situations, rather than hampered by location or technology. While voice connections fulfill the basic need to communicate, and mobile voice connections continue to filter even further into the fabric of every day life, the mobile Internet is the next step in the mobile communication revolution. The mobile Internet is poised to become a common source of everyday information, and easy, versatile mobile access to this data will be taken for granted.

Third generation (3G) cellular networks have been specifically designed to fulfill these future demands of the mobile Internet. As these services grow in popularity and usage, factors such as cost efficient optimization of network capacity and quality of service (QoS) will become even more essential to cellular operators than it is today. These factors may be achieved with careful network planning and operation, improvements in transmission methods, and advances in receiver techniques. To this end, carriers need technologies that will allow them to increase downlink throughput and, in turn, offer advanced QoS capabilities and speeds that rival those delivered by cable modem and/or DSL service providers.

In order to meet these demands, communication systems using multiple antennas at both the transmitter and the receiver have recently received increased attention due to their promise of providing significant capacity increase in a wireless fading environment. These multi-antenna configurations, also known as smart antenna techniques, may be utilized to mitigate the negative effects of multipath and/or signal interference on signal reception. It is anticipated that smart antenna techniques may be increasingly utilized both in connection with the deployment of base station infrastructure and mobile subscriber units in cellular systems to address the increasing capacity demands being placed on those systems. These demands arise, in part, from a shift underway from current voice-based services to next-generation wireless multimedia services that provide voice, video, and data communication.

The utilization of multiple transmit and/or receive antennas is designed to introduce a diversity gain and to raise the degrees of freedom to suppress interference generated within the signal reception process. Diversity gains improve system performance by increasing received signal-to-noise ratio and stabilizing the transmission link. On the other hand, more degrees of freedom allow multiple simultaneous transmissions by providing more robustness against signal interference, and/or by permitting greater frequency reuse for higher capacity. In communication systems that incorporate multi-antenna receivers, a set of M receive antennas may be utilized to null the effect of (M−1) interferers, for example. Accordingly, N signals may be simultaneously transmitted in the same bandwidth using N transmit antennas, with the transmitted signal then being separated into N respective signals by way of a set of N antennas deployed at the receiver. Systems that utilize multiple transmit and receive antennas may be referred to as multiple-input multiple-output (MIMO) systems. One attractive aspect of multi-antenna systems, in particular MIMO systems, is the significant increase in system capacity that may be achieved by utilizing these transmission configurations. For a fixed overall transmitted power and bandwidth, the capacity offered by a MIMO configuration may scale with the increased signal-to-noise ratio (SNR). For example, in the case of fading multipath channels, a MIMO configuration may increase system capacity by nearly M additional bits/cycle for each 3-dB increase in SNR.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for an improved MIMO modulation coding set feedback system, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating exemplary cellular multipath communication between a base station and a mobile computing terminal, in connection with an embodiment of the invention.

FIG. 1B is a diagram illustrating an exemplary MIMO communication system, in accordance with an embodiment of the invention.

FIG. 2 is a block diagram illustrating an exemplary MIMO transceiver chain model, in accordance with an embodiment of the invention.

FIG. 3 is a block diagram of an exemplary MIMO system with finite rate channel state information feedback, in accordance with an embodiment of the invention.

FIG. 4 is a spectral efficiency plot illustrating an exemplary modulation coding set with 15 levels, in accordance with an embodiment of the invention.

FIG. 5 is a spectral efficiency plot illustrating an exemplary modulation coding set for different SNR levels, in accordance with an embodiment of the invention.

FIG. 6 is a spectral efficiency plot for an exemplary 5 MHz OFDM downlink with a Minimum Mean Square Error (MMSE) receiver, in accordance with an embodiment of the invention.

FIG. 7 is a spectral efficiency plot for an exemplary 5 MHz OFDM downlink with an Ordered Successive Interference Cancellation (OSIC) receiver, in accordance with an embodiment of the invention.

### DETAILED DESCRIPTION OF THE INVENTION

Certain embodiments of the invention may be found in a method and system for an improved MIMO modulation coding set feedback system. Aspects of the method and system for an improved MIMO modulation coding set feedback system may comprise determining, for each one of a plurality of spatial streams in a MIMO system, an index associated with an element of a modulation coding set, based on at least a reference index and an offset variable. The plurality of spatial streams may be modulated and coded, based on the determined index. A reference feedback variable may be fed back from a receiver to a transmitter in the MIMO system. The reference index may be determined based on at least the reference feedback variable. The offset variable for each one of the plurality of spatial streams may be fed back from a receiver to a transmitter in the MIMO system.

A modulation and coding type for the reference spatial stream and the plurality of spatial streams may be selected based on the element of the modulation coding set associated with the reference index and the indices for each of the plurality of spatial streams, respectively. The reference index may be set to the value of the reference feedback variable or to a previous value of the reference index plus a reference feedback variable value. In various exemplary embodiments of the invention, the modulation coding set may comprise between about 8 and 32 elements. In one preferred embodiment of the invention, the modulation coding set may comprise 16 elements. The elements of the modulation coding set may be generated non-uniformly spaced or uniformly spaced with respect to spectral efficiency of the elements.

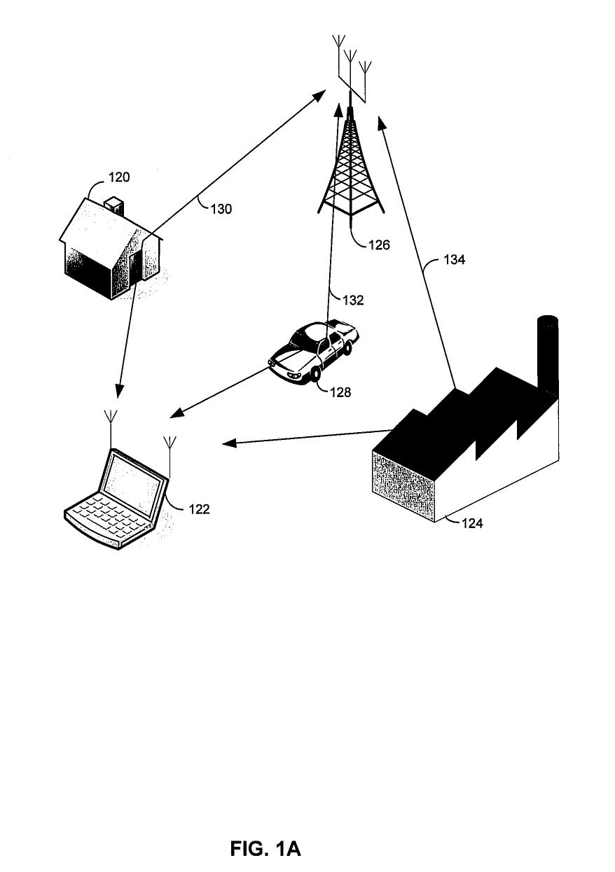

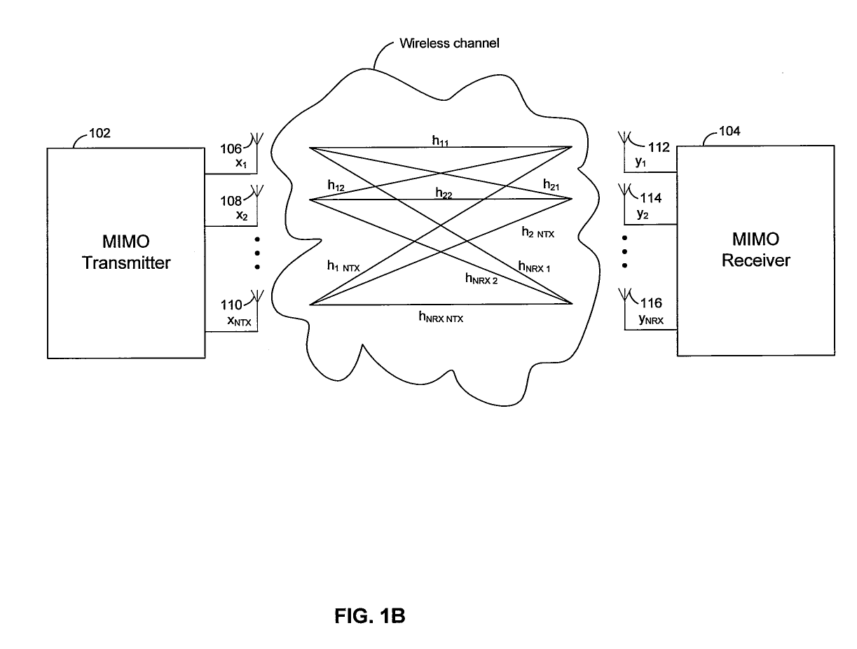

FIG. 1A is a diagram illustrating exemplary cellular multipath communication between a base station and a mobile computing terminal, in connection with an embodiment of the invention. Referring to FIG. 1A, there is shown a house 120, a mobile terminal 122, a factory 124, a base station 126, a car 128, and communication paths 130, 132 and 134.

The base station 126 and the mobile terminal 122 may comprise suitable logic, circuitry and/or code that may be enabled to generate and process MIMO communication signals. Wireless communications between the base station 126 and the mobile terminal 122 may take place over a wireless channel. The wireless channel may comprise a plurality of communication paths, for example, the communication paths 130, 132 and 134. The wireless channel may change dynamically as the mobile terminal 122 and/or the car 128 moves. In some cases, the mobile terminal 122 may be in line-of-sight (LOS) of the base station 126. In other instances, there may not be a direct line-of-sight between the mobile terminal 122 and the base station 126 and the radio signals may travel as reflected communication paths between the communicating entities, as illustrated by the exemplary communication paths 130, 132 and 134. The radio signals may be reflected by man-made structures like the house 120, the factory 124 or the car 128, or by natural obstacles like hills. Such a system may be referred to as a non-line-of-sight (NLOS) communications system.

A communication system may comprise both LOS and NLOS signal components. If a LOS signal component is present, it may be much stronger than NLOS signal components. In some communication systems, the addition of multiple signal components may create fading and reduce the receiver performance. This may be referred to as multipath fading. The communication paths 130, 132 and 134, for example, may arrive with different delays at the mobile terminal 122. The communication paths 130, 132 and 134 may also be differently attenuated. In the downlink, for example, the received signal at the mobile terminal 122 may be the sum of differently attenuated communication paths 130, 132 and/or 134 that may not be synchronized and that may dynamically change. Such a channel may be referred to as a fading multipath channel. A fading multipath channel may introduce performance loss but it may also introduce diversity and degrees of freedom into the wireless channel. Communication systems with multiple antennas at the base station and/or at the mobile terminal, for example MIMO systems, may be particularly suited to exploit the characteristics of wireless channels and may extract large performance gains from a fading multipath channel that may result in significantly increased performance with respect to a communication system with a single antenna at the base station 126 and at the mobile terminal 122.

FIG. 1B is a diagram illustrating an exemplary MIMO communication system, in accordance with an embodiment of the invention. Referring to FIG. 1B, there is shown a MIMO transmitter 102 and a MIMO receiver 104, and antennas 106, 108, 110, 112, 114 and 116. There is also shown a wireless channel comprising communication paths h₁₁, h₁₂, h₂₂, h₂₁, h_{2 NTX}, h_{1 NTX}, h_{NRX 1}, h_{NRX 2}, h_{NRX NTX}, where hₘₙ may represent a channel coefficient from transmit antenna n to receiver antenna m. There may be N_{TX} transmitter antennas and N_{RX} receiver antennas. There is also shown transmit symbols x₁, x₂ and x_{NTX}, and receive symbols y₁, y₂ and y_{NRX}

The MIMO transmitter 102 may comprise suitable logic, circuitry and/or code that may be enabled to generate transmit symbols xᵢ iε{1, 2, . . . N_{TX}} that may be transmitted by the transmit antennas, of which the antennas 106, 108 and 110 may be depicted in FIG. 1B. The MIMO receiver 104 may comprise suitable logic, circuitry and/or code that may be enabled to process the receive signals yᵢ iε{1, 2, . . . N_{RX}} that may be received by the receive antennas, of which the antennas 112, 114 and 116 may be shown in FIG. 1B. An input-output relationship between the transmitted and the received signal in a MIMO system may be written as:

y=Hx+n

where y=[y₁, y₂, . . . y_{NRX}]^{T} may be a column vector with N_{RX} elements, ^{T} may denote a matrix transpose, H=[hᵢⱼ]:iε{1, 2, . . . N_{RX}}; jε{1, 2, . . . N_{TX}} may be a channel matrix of dimensions N_{RX} by N_{TX}, x=[x₁, x₂, . . . x_{NTX}]^{T} is a column vector with N_{TX} elements and n is a column vector of noise samples with N_{RX} elements.

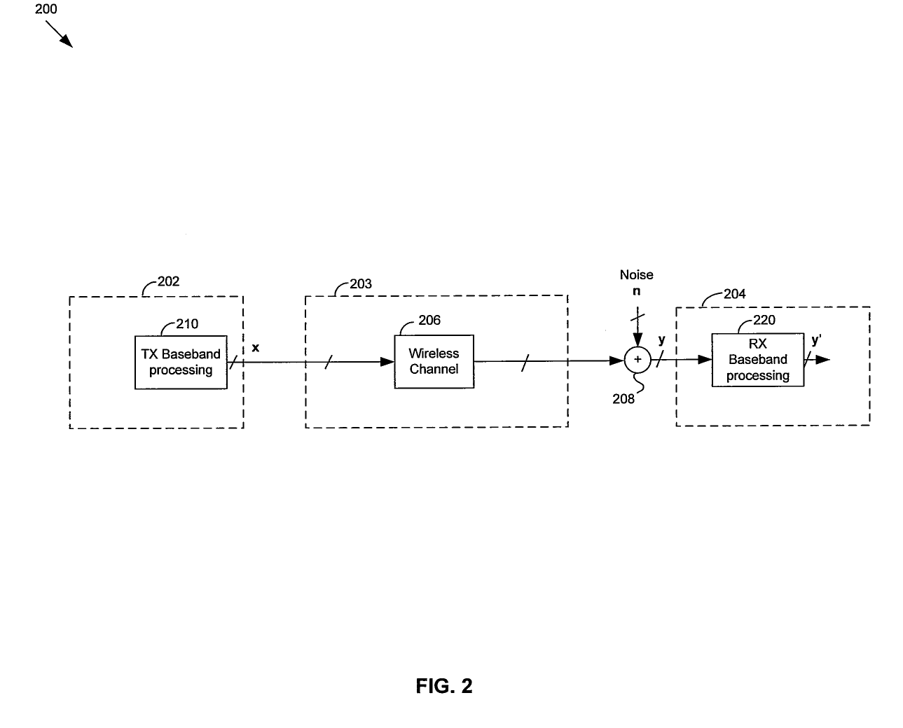

FIG. 2 is a block diagram illustrating an exemplary MIMO transceiver chain model, in accordance with an embodiment of the invention. Referring to FIG. 2, there is shown a MIMO system 200 that may comprise pre-coding comprising a MIMO transmitter 202, a MIMO baseband equivalent channel 203, a MIMO receiver 204, and an adder 208. The MIMO transmitter 202 may comprise a transmitter (TX) baseband processing block 210. The MIMO baseband equivalent channel 203 may comprise a wireless channel 206. The MIMO receiver 204 may comprise an RX baseband processing block 220. There is also shown transmit vector x, noise vector n, received vector y and decoded vector y′.

The MIMO transmitter 202 may comprise a baseband processing block 210, which may comprise suitable logic, circuitry and/or code that may be enabled to generate a MIMO baseband transmit signal. A baseband signal may be suitably enabled for transmission over a wireless channel 206 in the TX baseband processing block 210 that may comprise suitable logic, circuitry and/or code that may enable it to perform these functions, comprising radio frequency processing as required. The adder 208 may depict the addition of noise to the received signal at the MIMO receiver 204. The MIMO receiver 204 may comprise the RX baseband processing block 220 that may process a received signal y and may recover transmitted information bits. The RX baseband processing block 220 may comprise suitable logic, circuitry and/or logic that may be enabled to receive and process a radio frequency signal and to process baseband signal.

The column vector x=[x₁, x₂, . . . , x_{NTX}]^{T} may be generated at the TX baseband processing block 210. Each element of the transmitted vector x may be transmitted on a different antenna among N_{Tx} available transmit antennas. The transmitted vector x, which may be also pre-coded using a pre-coding matrix at the transmitter, may traverse the MIMO baseband equivalent channel 203. From the N_{RX} receiver antennas, the received signal y may be the signal x transformed by the MIMO baseband equivalent channel 203 represented by a matrix H, plus a noise component given by the noise vector n. As depicted by the adder 208, the received vector y may be given by y=Hx+n. The received vector y may be communicated to the RX baseband processing block 220, where a decoding operation B may be applied to the received vector y to obtain the decoded vector y′=B^{H}y=B^{H}Hx+B^{H}n, where B may be a complex matrix of appropriate dimensions.

If the transfer function H of the MIMO baseband equivalent channel 203 that may be applied to the transmitted vector x is known at the MIMO receiver 204, the channel may be diagonalizable by applying the receiver operation B. In some instances, using signal processing techniques, an appropriately designed receiver function B may lead to the product T=B^{H}H being a diagonal matrix. In general, this may not be possible and T=B^{H}H may be diagonalized in part. Notwithstanding, if a diagonal matrix element of T=B^{H}H, that is, the matrix element in row j and column j may be the only non-zero element in row j, then the j-th element xⱼ of the transmitted vector x may be received without interference generated by the elements xᵢ:i≠j in y′.

Using a suitable matrix B, it may be possible to decouple the signals xᵢ transmitted at the i-th antenna at the transmitter in a manner that the receiver may receive the data stream xᵢ at transmit antenna i without interference from the data streams sent from the other transmit antennas. For this reason, the data streams decoupled in such a manner may be referred to as spatial data streams since they may originate on different transmit antennas. The number of spatial data streams 1≦Nₛ=r≦min{N_{TX}, N_{RX}} that may be separated or decoupled may be limited by the rank r of the channel matrix H. The rank may be limited by the number of transmit antennas and the number of receive antennas. Each spatial stream originating at a transmit antenna may be modulated and coded separately.

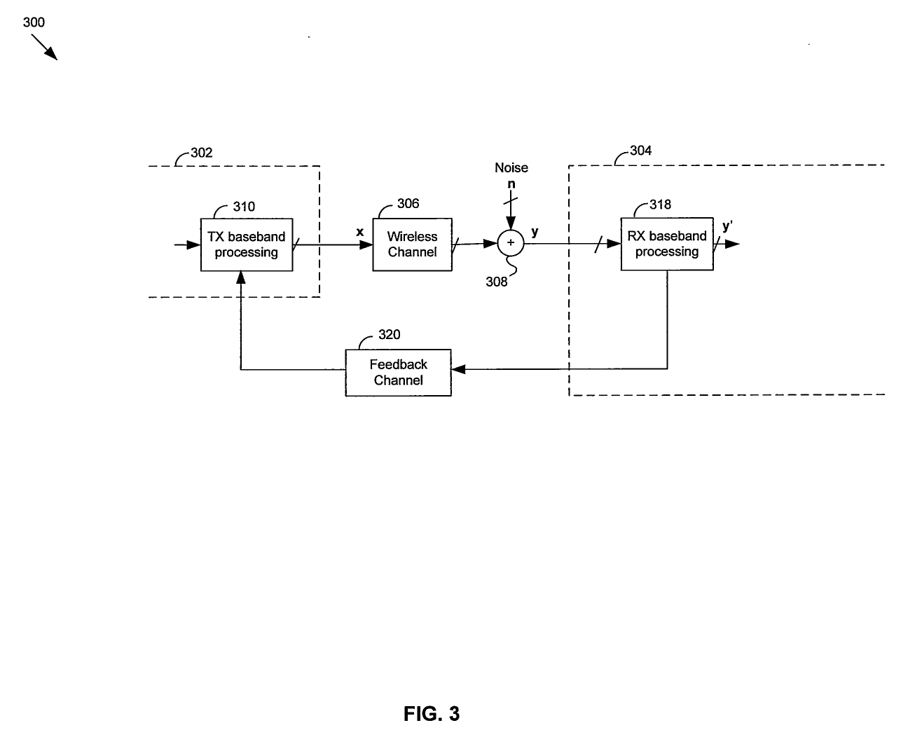

FIG. 3 is a block diagram of an exemplary MIMO system with finite rate channel state information feedback, in accordance with an embodiment of the invention. Referring to FIG. 3, there is shown a MIMO system 300 that may comprise pre-coding comprising a partial MIMO transmitter 302, a partial MIMO receiver 304, a wireless channel 306, an adder 308, and a feedback channel 320. The partial MIMO transmitter 302 may comprise a TX baseband processing block 310. The partial MIMO receiver 304 may comprise a RX baseband processing block 318. There is also shown a transmit vector x, a noise vector n, a received vector y, and a decoded vector y′.

The TX baseband processing block 310, the wireless channel 306, the adder 308 and the RX baseband processing block 318 may be substantially similar to the TX baseband processing block 210, the MIMO baseband equivalent channel 203, the adder 208 and the RX baseband processing block 220, illustrated in FIG. 2. The feedback channel 320 may represent a feedback link that may be enabled to carry channel state information from the partial MIMO receiver 304 to the partial MIMO transmitter 302.

In many wireless systems, the channel state information (CSI), that is, knowledge of the channel transfer matrix H or information derived from H, may not be available at the transmitter and the receiver. However, it may be desirable to have at least partial channel knowledge available at the transmitter. In some instances, values obtained through functions of the CSI may be transmitted from the receiver to the transmitter.

In frequency division duplex (FDD) systems, the frequency band for communications from the base station to the mobile terminal, downlink communications, may be different from the frequency band in the reverse direction, uplink communications. Because of a difference in frequency bands, a channel measurement in the uplink may not generally be useful for the downlink and vice versa. In these instances, the measurements may only be made at the receiver and CSI may be communicated back to the transmitter via feedback. For this reason, the CSI may be fed back to the TX baseband processing block 310 of the partial MIMO transmitter 302 from the partial MIMO receiver 304 via the feedback channel 320. The TX baseband processing block 310, the wireless channel 306, and the adder 308 are substantially similar to the corresponding blocks 210, 203 and 208, illustrated in FIG. 2.

In some instances, it may be possible that the different spatial stream may experience significantly different channel conditions. For example, an attenuation coefficient of one spatial stream may be significantly different from an attenuation coefficient of another spatial stream. For example, the Signal-to-Noise Ratio (SNR) or another performance measure may differ between the spatial streams. Accordingly, the modulation and/or coding of each spatial stream may be adapted independently. Adapting the modulation format and the coding rate for each spatial stream may be enabled by feeding back some channel state information or channel-based information from the partial MIMO receiver 304 to the partial MIMO transmitter 302 via the feedback channel 320.

The modulation and coding for each spatial stream may be chosen from a modulation coding set (MCS), which may comprise combinations of modulation constellations and coding rates that may be employed by the partial MIMO transmitter 302. For example, the modulation may be chosen from, but is not limited to, QPSK, 16QAM or 64QAM, where QPSK may denote quadrature phase shift keying and QAM may denote quadrature amplitude modulation. A coding rate may be chosen to be, for example, ⅓, ⅕ or ¾, whereby any rational number smaller than 1 may be feasible. A modulation coding set may comprise elements that may be formed by combining a modulation type with a coding rate. An exemplary element of a modulation coding set may be ‘QPSK ⅓’, which may denote a QPSK modulation with a coding rate of ⅓. A MCS may comprise N elements. In this case, the MCS may be referred to as an N-level MCS. In order to select an element from an N-level MCS at the partial MIMO receiver 304 and feed back the index indicating the appropriate element in the MCS from the partial MIMO receiver 304 to the partial MIMO transmitter 302 via the feedback channel 320, B≧log₂(N) bits of feedback may be required per spatial stream.

In order to reduce the number of bits required for feedback, a differential scheme may be implemented. In these instances, B≧log₂(N) bits may be transmitted for the spatial stream 1, for example, to transmit an index to an element of the MCS, as described above. The parameter sₖ may denote an MCS feedback value for spatial stream k. For the spatial streams 2 though Nₛ, an index offset value sₖ may be fed back from the partial MIMO receiver 304 to the partial MIMO transmitter 302. Such an offset value may, for example, take the values sₖε{0, ±1, ±2, ±3}:k=2, . . . , Nₛ. In this exemplary case, for spatial stream 2 through Nₛ, B_{d}=3 bits of feedback may be sufficient to feed back an offset value sₖ: k≠1 and for s₁ B=4 bits, for example. The required index to the MCS for spatial stream k may then be obtained from the feedback value for spatial stream 1 and the offset sₖ. The index q(k) may denote the index of the desired element in the MCS for user k. Hence, applying the above procedure, the partial MIMO transmitter 302 may determine the indices q(k) according to the following relationship:

q(j)=sⱼ:requiring B≧log₂(N) feedback bits

q(k)=q(j)+sₖ:∀k≠j, B_{d} feedback bits required for sₖ (1)

where j=1 may be as chosen above. The index j may be chosen to correspond to an arbitrary spatial stream, such that jε{1, 2, . . . , Nₛ}. For ease of exposition and clarity, j=1 may be assumed in the following description. When B_{d}<B, the number of bits that may be fed back from the partial MIMO receiver 304 to the partial MIMO transmitter 302 may be reduced. In some instances, due to a reduction in the number of feedback bits, the range of indices q(k) that may be addressed by q(k): k≠j may be limited to a subset of the MCS, since the addressable elements in the MCS and their associated indices q(k) may depend on the value sⱼ=s₁.

A further reduction in the number of feedback bits may be achieved by using a differential scheme also for spatial stream j=1. This may be done in instances where the channel conditions vary slowly enough to enable differential tracking of the new index based on an offset value added to the last instance of the index value. In this case, the index at time n for user k may be defined by the following relationship:

q₀(j)=sⱼ:requiring B≧log₂(N) feedback bits

qₙ(j)=qₙ₋₁(j)+sⱼ:B_{d} feedback bits required (2)

qₙ(k)=qₙ(j)+sₖ:∀k≠j, B_{d} feedback bits required

In this case, hence, the initial index for the spatial stream j=1 may be fed back using B bits, which may address any element in the MCS. For subsequent indices the channel may change slowly enough so that the previous index qₙ₋₁(j) may be used to determine the new index qₙ(j). It may be useful to reinitialize qₙ(j) occasionally.

It may be desirable to choose an appropriate number of levels for the MCS. In principle, N, the number of elements or levels of an N-level MCS, may be chosen to be any positive integer. However, since the index to an element of an N-level MCS may be fed back from the partial MIMO receiver 304 to the partial MIMO transmitter 302, it may be efficient to choose N as a power of 2. Furthermore, it may be undesirable to use both many and few levels. With few levels, the MCS may be relatively coarse, which may lead to a selection of a level that may be inefficient for the given channel conditions. On the other hand, an MCS with a large number of levels may provide a highly efficient match between the channel conditions and the selected level in the MCS. It may take comparatively long until the system settles, that is, the transient phase, also referred to as settling time, may be long. In addition, with a large number of levels, the differential protocol for the spatial streams 2 through Nₛ introduced above, may potentially result in a small dynamic range, which may be undesirable. Through simulation, it has been found that approximately N=16 levels enables good performance. The N<8 and N>32 levels have been found to result in unsatisfactory performance results due to the reasons outlined above.

For any level or element in the MCS, a spectral efficiency Seff may be approximated from the modulation constellation size M and the coding rate R, given by the following relationship:

Seff∝ log₂(M)·R

The spectral efficiency may be a measure of how efficiently the available bandwidth may be used and may be measured in, for example, bits/sec/Hz. The higher the spectral efficiency, the more efficient the use of the available bandwidth may be. For example, a 16QAM modulation (M=16) with a coding rate R=⅓ may enable a spectral efficiency proportional to 4/3 or 1.333. Simulations have shown that the system performance may improve if the N levels in the MCS may be non-uniformly spaced with respect to spectral efficiency. In other words, if a spectral efficiency range of, for example, 1-4 bits/s/Hz may be covered by the spectral efficiency of the MCS levels, it may generally be suboptimal to choose the MCS levels to be at, for example, 1, 2, 3 and 4 bits/s/Hz. Instead, it may be more efficient to use non-uniformly spaced levels, for example, levels at 1, 1.5, 2, and 4 bits/s/Hz. Simulations have shown that it may be desirable to space MCS levels more closely at lower spectral efficiency values and more widely at higher spectral efficiency values.

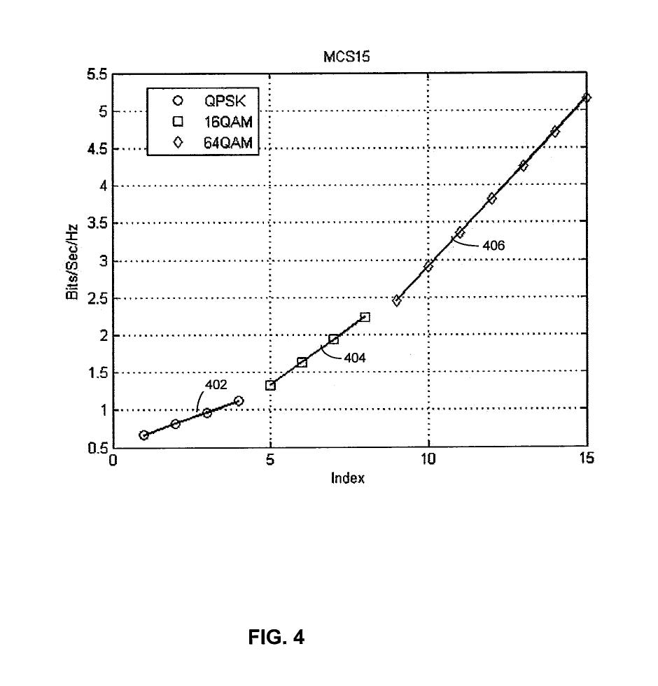

FIG. 4 is a spectral efficiency plot illustrating an exemplary modulation coding set with 15 levels, in accordance with an embodiment of the invention. Referring to FIG. 4, there is shown a set of QPSK modulated elements of the modulation coding set (QPSK-MCS) 402, a set of 16QAM modulated elements of the MCS (16QAM-MCS) 404, and a set of 64 QAM modulated elements of the MCS (64QAM-MCS) 406. There is also shown an SNR axis and a spectral efficiency (Seff) axis.

As described above with reference to FIG. 3, non-uniformly distributed spectral levels may be chosen for the elements of the MCS. For example, the 4 exemplary QPSK-MCS 402 levels may be seen to span a range of about 0.5 bits/sec/Hz for spectral efficiencies from approximately 0.75 bits/sec/Hz to approximately 1.25 bits/sec/Hz. In contrast, the first 4 exemplary levels of the 64QAM-MCS 406 may span a range of about 1.25 bits/sec/Hz from approximately 2.5 bits/sec/Hz to approximately 3.75 bits/sec/Hz. Hence, as described for FIG. 3, the levels may be more coarsely spaced for higher spectral efficiency levels. In other embodiments of the invention, the levels of the modulation coding set may be chosen differently.

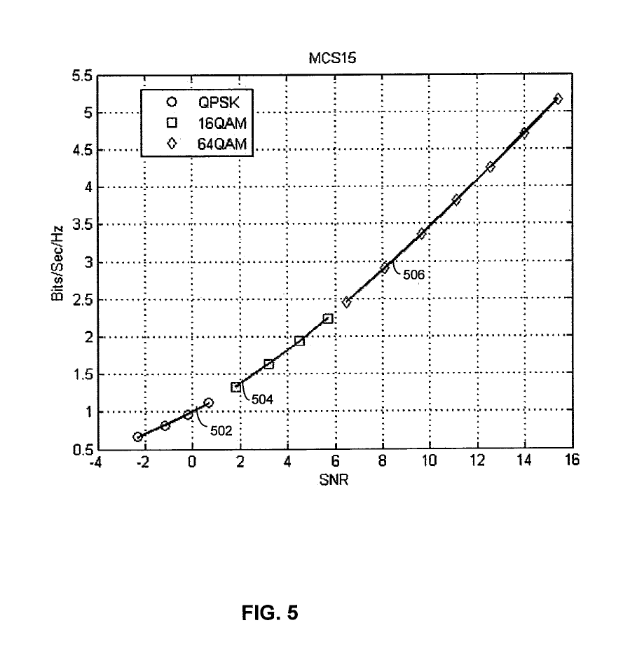

FIG. 5 is a spectral efficiency plot illustrating an exemplary modulation coding set for different SNR levels, in accordance with an embodiment of the invention. Referring to FIG. 5, there is shown a set of QPSK modulated elements of the modulation coding set (QPSK-MCS) 502, a set of 16QAM modulated elements of the MCS (16QAM-MCS) 504, and a set of 64 QAM modulated elements of the MCS (64QAM-MCS) 506. There is also shown an SNR axis and a spectral efficiency (Seff) axis.

This figure may illustrate the Signal-to-Noise Ratio (SNR) in decibel (dB) that may be required in order to enable each of the 15 levels of the MCS introduced in FIG. 4. The levels QPSK-MCS 402, 16QAM-MCS 404, 64QAM-MCS 406 in FIG. 4 may correspond to the levels QPSK-MCS 502, 16QAM-MCS 504, 64QAM-MCS 506, respectively. It may be observed that higher levels of SNR may be necessary to operate at higher spectral efficiency.

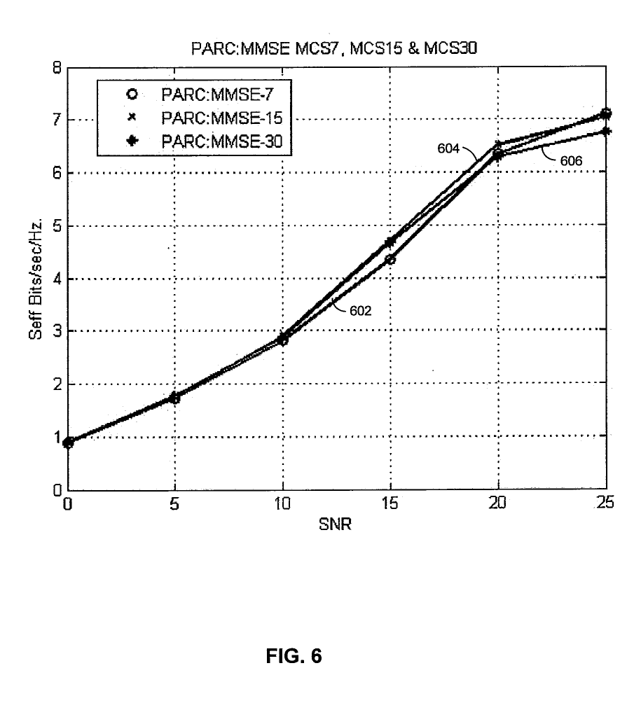

FIG. 6 is a spectral efficiency plot for an exemplary 5 MHz OFDM downlink with a Minimum Mean Square Error (MMSE) receiver, in accordance with an embodiment of the invention. Referring to FIG. 6, there is shown a Per Antenna Rate Control (PARC) with a Minimum Mean Square Error (MMSE) receiver in conjunction with a 7-level MCS, PARC:MMSE-7 602, a PARC:MMSE-15 604, and a PARC:MMSE-30 606. There is also shown an SNR axis and a spectral efficiency (Seff) axis.

It may be seen from FIG. 6 that the PARC:MMSE-7 602 may perform less well than the other two protocols in the 10-20 dB SNR range. This may be due to the coarse MCS level granularity because of the 7 MCS levels. The PARC:MMSE-30 606 may offer finer granularity because of the 30 levels. However, the performance gains may be limited in the range of 10-20 dB SNR and at higher SNRs above 20 dB, the obtained performance may be even weaker. The PARC:MMSE-15 604 may offer sufficient granularity and good performance across the operating region depicted.

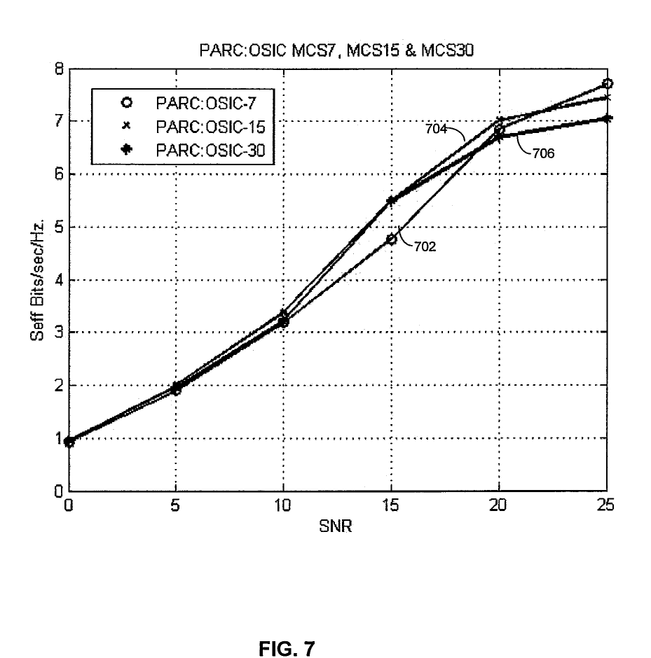

FIG. 7 is a spectral efficiency plot for an exemplary 5 MHz OFDM downlink with an Ordered Successive Interference Cancellation (OSIC) receiver, in accordance with an embodiment of the invention. Referring to FIG. 7, there is shown a Per Antenna Rate Control (PARC) with an Ordered Successive Interference Cancellation (OSIC) receiver in conjunction with a 7-level MCS, PARC:OSIC-7 702, a PARC:OSIC-15 704, and a PARC:OSIC-30 706. There is also shown an SNR axis and a spectral efficiency (Seff) axis.

It may be observed from FIG. 7 that the performance loss of the 7-level MCS shown in the PARC:OSIC-7 702 plot may be accentuated in the region from approximately 10-20 dB SNR. This may be due to the coarse MCS level granularity because of the 7 MCS levels. The PARC:OSIC-30 706 may exhibit similar performance as observed in FIG. 6: a good performance in the region of 10-20 dB and decreasing performance with reference to PARC:OSIC-15 704 in the SNR range above 20 dB. As for FIG. 6, the 15-level MCS shown in the PARC:OSIC-15 704 plot may offer good performance across the operating range depicted.

In accordance with an embodiment of the invention, a method and system for an improved MIMO modulation coding set feedback system may comprise determining, for each one of a plurality of spatial streams in a MIMO system 300 as illustrated in FIG. 3, an index associated with an element of a modulation coding set, based on at least a reference index and an offset variable, for example at the RX baseband processing block 320 comprised in the partial MIMO receiver 304. The plurality of spatial streams may be modulated and coded at the TX baseband processing block 310 of the partial MIMO transmitter 302, based on the determined index. A reference feedback variable may be fed back from a MIMO receiver 304 to a MIMO transmitter 302 in the MIMO system 300. The reference index may be determined based on at least the reference feedback variable. The offset variable for each one of the plurality of spatial streams may be fed back from a MIMO receiver 304 to a MIMO transmitter 302 in the MIMO system 300.

A modulation and coding type for the reference spatial stream and the plurality of spatial streams may be selected based on the element of the modulation coding set associated with the reference index and the indices for each of the plurality of spatial streams, respectively, as described for FIG. 3. The reference index may be set to the value of the reference feedback variable, as shown in equation (1) or to a previous value of the reference index plus a reference feedback variable value, as shown in equation (2). In a preferred embodiment of the invention, the modulation coding set may comprise about 16 elements, as described for FIG. 3. In other embodiments of the invention, the modulation coding set may comprise between about 8 and 32 elements. As elaborated and illustrated in FIG. 3, FIG. 4, FIG. 5, FIG. 6 and FIG. 7, the elements of the modulation coding set may be generated non-uniformly spaced or uniformly spaced with respect to spectral efficiency of the elements.

Another embodiment of the invention may provide a machine-readable storage, having stored thereon, a computer program having at least one code section executable by a machine, thereby causing the machine to perform the steps as described above for a method and system for an improved MIMO modulation coding set feedback system.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing communication signals, the method comprising:
determining, for each one of a plurality of spatial streams in a MIMO system, an index associated with an element of a modulation coding set, based on at least a reference index and an offset variable; and
coding and modulating said plurality of spatial streams, based on said determined index.

2. The method according to claim 1, comprising feeding back, from a receiver to a transmitter in said MIMO system, a reference feedback variable.

3. The method according to claim 1, comprising determining said reference index based on at least a reference feedback variable.

4. The method according to claim 1, comprising feeding back, from a receiver to a transmitter in said MIMO system, said offset variable for each one of said plurality of spatial streams.

5. The method according to claim 1, comprising selecting a modulation type for said modulating of each one of said plurality of spatial streams, based on said element of said modulation coding set associated with said index of each one of said plurality of spatial streams.

6. The method according to claim 1, comprising selecting a coding type for said coding of each one of said plurality of spatial streams, based on said element of said modulation coding set associated with said index of each one of said plurality of spatial streams.

7. The method according to claim 1, wherein said reference index is set to a value of a reference feedback variable.

8. The method according to claim 1, wherein said reference index is set to a value equal to a previous value of said reference index plus a reference feedback variable value.

9. The method according to claim 1, wherein said index is set to a value equal to said reference index plus said offset variable, for each one of said plurality of spatial streams.

10. The method according to claim 1, wherein said modulation coding set comprises about 16 of said elements.

11. The method according to claim 1, wherein said modulation coding set comprises between 8 and 32 of said elements.

12. The method according to claim 1, comprising generating said elements of said modulation coding set non-uniformly spaced with respect to spectral efficiency of said elements.

13. The method according to claim 1, comprising generating said elements of said modulation coding set uniformly spaced with respect to spectral efficiency of said elements.

14. A system for processing communication signals, the system comprising:
a MIMO system comprising one or more circuits, said one or more circuits enable:
determination, for each one of a plurality of spatial streams in said MIMO system, of an index associated with an element of a modulation coding set, based on at least a reference index and an offset variable; and
coding and modulation of said plurality of spatial streams, based on said determined index.

15. The system according to claim 14, wherein said one or more circuits feed back, from a receiver to a transmitter in said MIMO system, a reference feedback variable.

16. The system according to claim 14, wherein said one or more circuits determine said reference index based on at least a reference feedback variable.

17. The system according to claim 14, wherein said one or more circuits feed back, from a receiver to a transmitter in said MIMO system, said offset variable for each one of said plurality of spatial streams.

18. The system according to claim 14, wherein said one or more circuits select a modulation type for said modulating of each one of said plurality of spatial streams, based on said element of said modulation coding set associated with said index of each one of said plurality of spatial streams.

19. The system according to claim 14, wherein said one or more circuits select a coding type for said coding of each one of said plurality of spatial streams, based on said element of said modulation coding set associated with said index of each one of said plurality of spatial streams.

20. The system according to claim 14, wherein said reference index is set to a value of a reference feedback variable.

21. The system according to claim 14, wherein said reference index is set to a value equal to a previous value of said reference index plus a reference feedback variable value.

22. The system according to claim 14, wherein said index is set to a value equal to said reference index plus said offset variable, for each one of said plurality of spatial streams.

23. The system according to claim 14, wherein said modulation coding set comprises about 16 of said elements.

24. The system according to claim 14, wherein said modulation coding set comprises between 8 and 32 of said elements.

25. The system according to claim 14, wherein said one or more circuits generate said elements of said modulation coding set non-uniformly spaced with respect to spectral efficiency of said elements.

26. The system according to claim 1, wherein said one or more circuits generate said elements of said modulation coding set uniformly spaced with respect to spectral efficiency of said elements.
